(19) United States
(12) Patent Application Publication
(10) Pub. No.: US 2014/0104199 A1
(43) Pub. Date: Apr. 17, 2014

(54) TOUCH PANEL AND METHOD FOR MANUFACTURING THE SAME

(71) Applicant: SAMSUNG ELECTRO-MECHANICS CO., LTD., Suwon (KR)

(72) Inventors: Seung Min Lee, Suwon (KR); Ho Joon Park, Suwon (KR); Youn Soo Kim, Suwon (KR)

(73) Assignee: SAMSUNG ELECTRO-MECHANICS CO., LTD., Suwon (KR)

(21) Appl. No.: 13/753,635

(22) Filed: Jan. 30, 2013

(30) Foreign Application Priority Data
Oct. 15, 2012 (KR) 10-2012-0114311

(51) Int. Cl. G06F 3/041

(52) U.S. Cl. CPC G06F 3/041
USPC 345/173

(57) ABSTRACT

Disclosed herein are a touch panel and a method for manufacturing the same, the touch panel, including: a transparent substrate; first sensing electrodes formed in a first direction on one surface of the transparent substrate to sense a change in capacitance at the time of inputting a touch; second sensing electrodes disposed in the first direction on a surface, which is in parallel spaced from the surface on which the first sensing electrodes are formed, alternately with the first sensing electrodes, to sense a change in capacitance at the time of inputting a touch; and driving electrodes formed in a second direction crossing the first direction on the other surface of the transparent substrate, so that sensing sensibility can improved by including a multiple-layered sensing electrode layer.

### CROSS REFERENCE TO RELATED APPLICATION

This application claims the benefit of Korean Patent Application No. 10-2012-0114311, filed on Oct. 15, 2012, entitled “Touch Panel and Method for Manufacturing the Same”, which is hereby incorporated by reference in its entirety into this application.

### BACKGROUND OF THE INVENTION

1. Technical Field

The present invention relates to a touch panel and a method for manufacturing the same.

2. Description of the Related Art

With the development of computers using digital technology, devices assisting the computers have also been developed, and personal computers, portable transmitters and other personal information processors execute processing of text and graphics using a variety of input devices such as a keyboard, a mouse and the like.

While the rapid advancement of an information-oriented society has been widening the use of computers more and more, it is difficult to efficiently operate products using only a keyboard and mouse currently serving as an input device. Therefore, the need for a device that is simple, has minimum malfunction, and is capable of easily inputting information has increased.

Furthermore, current techniques for input devices exceed the level of fulfilling general functions and thus are progressing towards techniques related to high reliability, durability, innovation, designing and manufacturing. To this end, a touch panel has been developed as an input device capable of inputting information such as text and graphics.

The touch panel is mounted on the display surface of an image display device such as an electronic organizer, a flat panel display including a liquid crystal display (LCD), a plasma display panel (PDP), an electroluminescence (El) element, or the like, or a cathode ray tube (CRT), so that a user selects desired information while viewing the image display device.

The touch panel is classifiable as a resistive type, a capacitive type, an electromagnetic type, a surface acoustic wave (SAW) type, and an infrared type. These various types of touch panels are adapted for electronic products in consideration of signal amplification problems, resolution difference, level of difficulty of designing and processing technologies, optical characteristics, electrical characteristics, mechanical characteristics, environment-resistant characteristics, input characteristics, durability, and economic efficiency. Currently, a capacitive type touch panel and a digital resistive type touch panel have been used in a wide range of fields.

The capacitive type touch panel is composed of two transparent substrates, transparent electrodes, and an adhesive layer.

Here, the transparent electrodes are formed on the respective transparent substrates, and the adhesive layer is formed between entire surfaces of the two transparent substrates. In the case of input by a user, the transparent electrode functions as an electrode and the transparent substrate functions as a dielectric substance, to thereby induce parasitic capacitance, so that a change in capacitance due to the parasitic capacitance may be sensed.

However, as for the existing capacitive type touch panel, when a user touches the transparent substrate by using a finger nail or an acute thing with a small area, such as, a stylus pen or the like, a very small amount of parasitic capacitance is generated, thereby hardly changing capacitance, such that the touch may not be recognized.

The touch panel disclosed in Patent Document 1 below is composed of a plurality of first (X-directional) electrodes and second (Y-directional) electrodes and a third electrode having a surface shape and covering them, and a gel type sheet is prepared between the plurality of first and second electrodes and the third electrode. However, in this touch panel, the change in capacitance occurring due to transformation of the gel type sheet is sensed, and thus a transformable gel type sheet needs to be prepared in order to improve sensitivity of the touch panel. Moreover, if a pressure having a predetermined level for the transformation is not applied, sensitivity of the sensor may not be improved.

### PRIOR ART DOCUMENT

### Patent Document

(Patent Document 1) Japanese Patent Laid-Open Publication No. 2008-160272

### SUMMARY OF THE INVENTION

The present invention has been made in an effort to provide a touch panel and a method for manufacturing the same, capable of maximizing sensitivity of a sensor.

The present invention has been also made in an effort to provide a touch panel and a method for manufacturing the same, capable of improving sensitivity by touch regardless of how hard pressure is applied.

According to a preferred embodiment of the present invention, there is provided a touch panel, including: a transparent substrate; first sensing electrodes formed in a first direction on one surface of the transparent substrate to sense a change in capacitance at the time of inputting a touch; second sensing electrodes disposed in the first direction on a surface, which is in parallel spaced from the surface on which the first sensing electrodes are formed, alternately with the first sensing electrodes, to sense a change in capacitance at the time of inputting a touch; and driving electrodes formed in a second direction crossing the first direction on the other surface of the transparent substrate.

The touch panel may further include an insulating layer formed on the transparent substrate, the first sensing electrodes and the second sensing electrodes being formed in the insulating layer.

The first sensing electrodes and the second sensing electrodes for each occurrence may be uniformly disposed at a predetermined arrangement pitch.

The touch panel may further include an anti-reflection layer formed below the transparent substrate.

The may further include a first adhesive layer allowing the transparent substrate and the anti-reflection layer to adhere to each other.

The touch panel may further include a protecting layer formed above the insulating layer.

The touch panel may further include a second adhesive layer allowing the insulating layer and the protecting layer to adhere to each other.

The protecting layer may be formed of any one of glass, polyethylene terephthalate (PET), and a hard coat film.

According to another preferred embodiment of the present invention, there is provided a method for manufacturing a touch panel, the method including: forming first sensing electrodes in a first direction on an upper surface of a transparent substrate and second sensing electrodes in the first direction on a surface, which is in parallel spaced from the surface on which the first sensing electrodes are formed, alternately with the first sensing electrodes; and forming driving electrodes in a second direction crossing the first direction on a lower surface of the transparent substrate.

The method may further include forming an insulating layer covering the first sensing electrodes and the second sensing electrodes.

The method may further include: forming a protecting layer above the insulating layer; and forming an anti-reflection layer below the transparent substrate.

The method may further include: forming a first adhesive layer between the transparent substrate and the anti-reflection layer; and forming a second adhesive layer between the insulating layer and the protecting layer.

### BRIEF DESCRIPTION OF THE DRAWINGS

The above and other objects, features, and advantages of the present invention will be more clearly understood from the following detailed description taken in conjunction with the accompanying drawings, in which:

FIG. 1 is a cross-sectional view of a touch panel according to a preferred embodiment of the present invention;

FIGS. 2A to 2C are cross-sectional views showing other modifications of a sensing electrode layer provided in the touch panel shown in FIG. 1;

FIG. 3 is a plan view of an electrode arrangement of the touch panel shown in FIG. 1; and

FIG. 4 is a view for explaining an operating manner of the touch panel shown in FIG. 1.

### DESCRIPTION OF THE PREFERRED EMBODIMENTS

The objects, features and advantages of the present invention will be more clearly understood from the following detailed description of the preferred embodiments taken in conjunction with the accompanying drawings. Throughout the accompanying drawings, the same reference numerals are used to designate the same or similar components, and redundant descriptions thereof are omitted. Further, in the following description, the terms “first”, “second”, “one side”, “the other side” and the like are used to differentiate a certain component from other components, but the configuration of such components should not be construed to be limited by the terms. Further, in the description of the present invention, when it is determined that the detailed description of the related art would obscure the gist of the present invention, the description thereof will be omitted.

Meanwhile, the term ‘touch’ used herein is widely construed as meaning a direct contact to a contact accepting surface as well as meaning that an input unit approaches the contact accepting surface within a considerable distance. That is, the touch panel according to the present invention should be construed as a touch panel having a function of recognizing contact by the input unit or approach of the input unit within a considerable distance.

Hereinafter, preferred embodiments of the present invention will be described in detail with reference to the accompanying drawings.

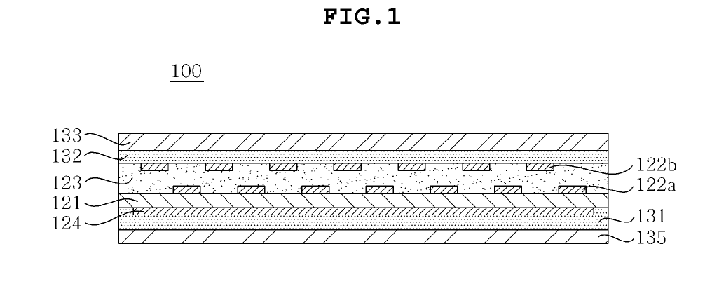

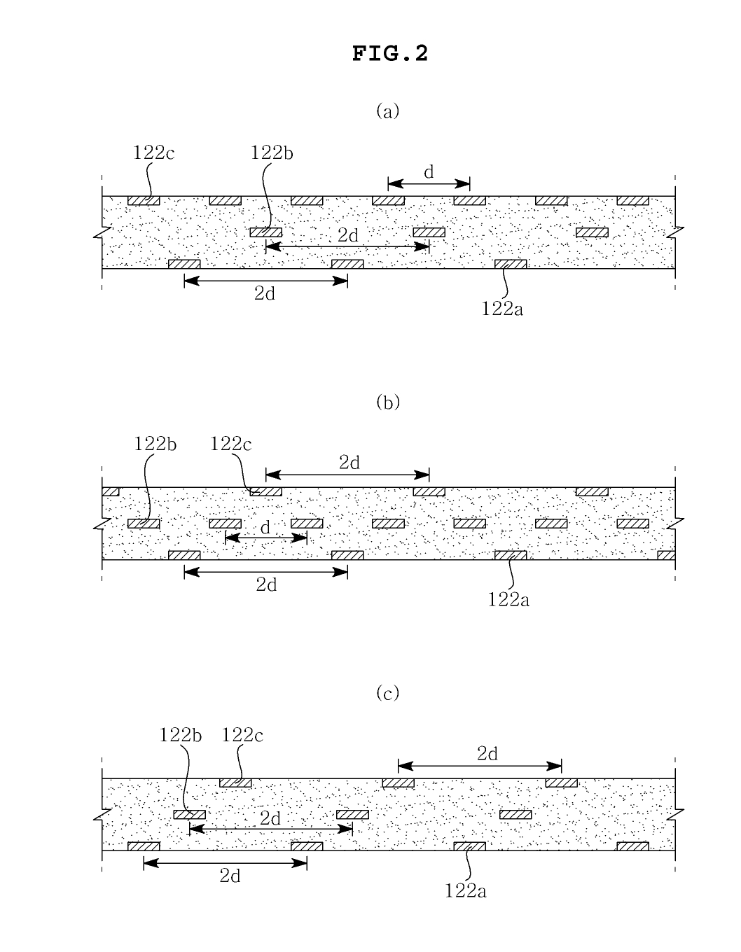

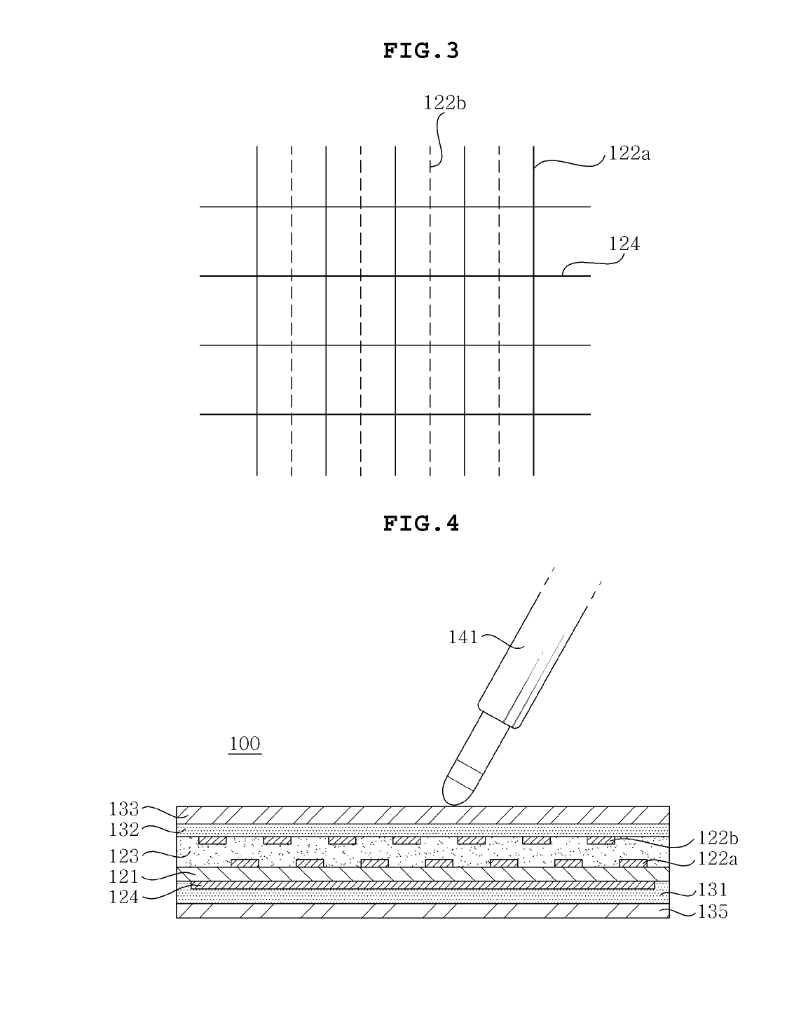

FIG. 1 is a cross-sectional view of a touch panel according to a preferred embodiment of the present invention; FIGS. 2A to 2C are cross-sectional views showing other modifications of a sensing electrode layer provided in the touch panel shown in FIG. 1; FIG. 3 is a plan view of an electrode arrangement of the touch panel shown in FIG. 1; and FIG. 4 is a view for explaining an operating manner of the touch panel shown in FIG. 1. Hereafter, a touch panel 100 according to the present embodiment will be described with reference to the accompanying drawings.

As shown in FIG. 1, the touch panel 100 according to the present preferred embodiment may include a transparent substrate 121, first sensing electrodes 122a, second sensing electrodes 122b, an insulating layer 123, driving electrodes 124, and a protecting layer 133.

The transparent substrate 121 serves to provide an area where the first sensing electrodes 122a and the driving electrodes 124 are to be formed. Here, the transparent substrate 121 needs to retain support force to support the first sensing electrodes 122a and the driving electrodes 124 and transparency to allow a user to recognize an image provided by an image display device. Considering the foregoing support force and transparency, the transparent substrate 121 may be formed of polyethylene terephthalate (PET), polycarbonate (PC), polymethylmethacrylate (PMMA), polyethylene naphthalate (PEN), polyether sulfone (PES), cyclic olefin copolymer (COC), a triacetylcellulose (TAC) film, a polyvinyl alcohol (PVA) film, a polyimide (PI) film, polystyrene (PS), biaxially oriented polystyrene (BOPS; K resin containing biaxially oriented PS), glass, tempered glass, or the like, but is not necessarily limited thereto. In addition, the transparent substrate 121 may have flexibility, as necessary.

In addition, the first sensing electrodes 122a and the driving electrodes 124 are formed on both surfaces of the transparent substrate 121, respectively, and thus, in order to improve adhesion therebetween, a high frequency treatment or a primer treatment is preferably performed on the transparent substrate 121.

In addition, the transparent substrate 121 serves to provide an area where electrode wirings (not shown) are to be formed. Here, the transparent substrate 121 is divided into an active area and a bezel area. The active area is provided at the center of the transparent substrate 121. Electrode patterns such as the first sensing electrodes 122a and the driving electrodes 124 are formed in the active area so that touch by the input unit can be recognized. The electrode wirings electrically conducted with the electrode patterns are formed in the bezel area, which is provided at the edge of the active area. The bezel area is connected to a controller, which is a kind of a control part, through the electrode wirings. Here, the control part may be provided separately with the transparent substrate 121 to be connected to a flexible printed circuit (FPC) or may be provided on the transparent substrate 121.

The first sensing electrodes 122a, the second sensing electrodes 122b, and the driving electrodes 124 may be formed on both surfaces of the transparent substrate 121, to sense a change in capacitance from a touch input.

The first sensing electrodes 122a are formed on one surface of the transparent substrate 121 in one direction. The second sensing electrodes 122b are formed on a surface, which is in parallel spaced apart from the surface on which the first sensing electrodes are formed, in the same direction as the first sensing electrodes 122a. In addition, the driving electrodes 124 are formed on the other surface of the transparent substrate 121 in a direction crossing the direction in which the sensing electrodes 122a and 122b are formed. As such, the second sensing electrode 122b is added on the first sensing electrode 122a constituting one layer, and thus a plural-layered electrode layer is formed.

Here, the first sensing electrodes 122a and the sensing electrodes 122b are preferably disposed alternately with each other. In addition, different distances between the driving electrodes 124 and the sensing electrodes 122a and 122b are preferably formed for each electrode layer. Due to the difference in distance, the interval of an electric field that is recognizable is further divided. As a result, the formation of the multi-layered electrode layer results in improvement in sensing sensitivity.

In the preferred embodiment shown in FIG. 1, the two-layered electrode layer is formed, but the present invention is not limited thereto, for example, three-, four-, or more-layered electrode layer may be formed.

FIGS. 2A to 2C show various modifications of a three-layered electrode layer.

The three-layered electrode layer is composed of first sensing electrodes 122a, second sensing electrodes 122b, and third sensing electrodes 122c, which are uniformly disposed at a predetermined arrangement pitch in each electrode layer. The sensing electrodes 122a, 122b, or 122c in each electrode layer are disposed alternately with each other.

As show in FIG. 2A, the first sensing electrodes 122a and the second sensing electrodes 122b for each occurrence are disposed at the same arrangement pitch, 2d, and the third sensing electrodes 122c are disposed at a shorter arrangement pitch, d. As shown in FIG. 2B, the first sensing electrodes 122a and the third sensing electrodes 122c for each occurrence are disposed at the same arrangement pitch, 2d, and the second sensing electrodes 122b are disposed at a shorter arrangement pitch, d. As shown in FIG. 2C, the first sensing electrodes 122a, the second sensing electrodes 122c, and the third sensing electrodes 122c for each occurrence are disposed at the same arrangement pitch, 2d. Although not shown herein, the sensing electrodes may be arranged in various manners, considering convenience of process or sensing sensitivity.

Meanwhile, the first sensing electrodes 122a, the second sensing electrodes 122b, and the driving electrodes 124 may be arranged as shown in FIG. 3. That is, the first sensing electrodes 122a and the second sensing electrode 122b are arranged side by side in a Y axis direction, and the driving electrodes 124 are arranged in an X axis direction. Each of the sensing electrodes 122b is arranged between the first sensing electrodes 122a at a predetermined distance, to allow generation of uniform high frequency.

As described above, the driving electrodes 124 in an X axis direction and the sensing electrodes 122a and 122b in a Y axis direction are formed to measure parasitic capacitance from a touch input, and then sense a difference in capacitance, which is transferred to a control part (not shown). The control part (not shown) recognizes a coordinate of a pressed location and thus implements a desired operation. Specifically, when the touch input occurs after high frequency is spread on the entire surfaces of the first sensing electrode 122a and the second sensing electrode 122b by applying a voltage through the driving electrodes 124, a predetermined change in capacitance while the first sensing electrodes 122a or the second sensing electrodes 122b serve as electrodes and the transparent substrate 121 serves as a dielectric substance. The control part (not shown) senses a transformed waveform to allow recognition of a touched location or whether or not a touch occurs.

Meanwhile, it is preferable that the first sensing electrodes 122a, the second sensing electrodes 122b, and the driving electrodes 124 are formed of a transparent material so that a user can see a display (not shown) under the touch panel 110, and further, of a material having conductivity. For example, the first sensing electrodes 122a, the second sensing electrodes 122b, and the driving electrodes 124 may be formed of a conductive polymer where poly-3, 4-ethylenedioxythiophene/polystyrenesulfonate (PEDOT/PSS), polyaniline, or the like, is used alone or in mixture, or metal oxide such as indium tin oxide (ITO) or the like. Here, in the case where the first sensing electrodes 122a, the second sensing electrodes 122b, and the driving electrodes 124 are formed of the conductive polymer, they are flexible, so that, even though they are frequently bent toward the transparent substrate 121, the defective rate of the touch panel can be reduced. Here, in the case of using the conductive polymer, the first sensing electrodes 122a, the second sensing electrodes 122b, and the driving electrodes 124 may be formed on the transparent substrate 121 by a silkscreen printing method, an inkjet printing method, a gravure printing method, an offset printing method, or the like.

FIG. 1 shows that the first sensing electrodes 122a, the second sensing electrodes 122b, and the driving electrodes 124 have a rod shape, but this is merely exemplified, and for example, they may be formed in various shapes such as a rhombic shape, a hexagonal shape, an octagonal shape, a triangular shape, or the like.

The insulating layer 123 serves to protect the first sensing electrodes 122a and the second sensing electrodes 122b, and is formed on the transparent substrate 121. Here, the insulating layer 123 may be formed of an organic insulating film or an inorganic insulating film by printing, chemical vapor deposition (CVD), sputtering, or the like.

Here, the insulating layer 123 may be formed of epoxy or acrylic resin, a SiOx thin film, or a SiNx thin film.

In addition, the insulating layer 123 may be formed of for example an adhesive material. In this case, an upper adhesive layer 132 shown in FIG. 1 is not necessary.

The protecting layer 133 is positioned on an outer surface of the touch panel 100 to receive a touch input from a particular object such as a body of the user, a stylus pen, or the like.

Here, the protective layer 133 is preferably formed of a material having high durability enough to protect the other components of the touch panel 100. In addition, the protecting layer is preferably formed of a material having elasticity so that it is bent by receiving a touch input and returned to its original position when the touch input is released, in order to transfer intensity of the pressure. Also, the protecting layer 133 is preferably formed of a transparent material so that an image from a display (not shown) installed under the touch panel 100 can be clearly transferred to a user. As this material, the protecting layer 133 may be formed of, for example, polyethyleneterephthalate (PET), polycarbonate (PC), polymethylmetacrylate (PMMA), polyethylenenaphthalenedicarboxylate (PEN), polyethersulfone (PES) or cyclic olefin copolymer (COC). Besides, glass or tempered glass generally used may be utilized. In addition, a hard coat film, which is a kind of film, may be used. In this case, a difference in transformation between when a touch surface of the touch panel 100 is pressed and when the touch surface of the touch panel 100 is not pressed is generated, and this difference is used to determine the degree of pressure applied.

It is preferable to further add an anti-reflection (AR) layer 135 at a lower portion of the touch panel 100.

A lower adhesive layer 131 is formed between the transparent substrate 121 and the anti-reflection layer 135, to adhere the transparent substrate 121 and the anti-reflection layer 135 to each other. An upper adhesive layer 132 is formed between the protecting layer 133 and the insulating layer 123, to adhere the protecting layer 133 and the insulating layer 123 to each other. Here, a material for the adhesive layers 131 and 132 is not particularly limited, but a transparent optical clear adhesive (OCA) is preferably used so that a user can recognize an image outputted from an image display device (not shown) without interference. Edge portions thereof may adhere to each other by using a double adhesive tape (DAT).

Meanwhile, referring to FIG. 1, a method for manufacturing the touch panel according to the preferred embodiment of the present invention may include: forming first sensing electrodes 122a in a first direction on an upper surface of a transparent substrate 121 and second sensing electrodes 122b in the first direction on a surface, which is in parallel spaced from the surface on which the first sensing electrodes 122a are formed, alternately with the first sensing electrodes 122a; and forming driving electrodes 124 in a second direction crossing the first direction on a lower surface of the transparent substrate 121.

In the case where the first sensing electrodes 122a, the second sensing electrodes 122b, and the driving electrodes 124 are formed of a conductive polymer, they may be formed on the transparent substrate 121 by a silkscreen printing method, an inkjet printing method, a gravure printing method, an offset printing method, or the like.

Here, the method for manufacturing a touch panel according to the present invention may include forming an insulating layer covering the first sensing electrodes 122a and the second sensing electrodes 122b. The insulating layer 123 may be formed of an organic insulating film or an inorganic insulating film by printing, chemical vapor deposition (CVD), sputtering, or the like.

In addition, preferably, the method according to the present invention may further include forming a protecting layer 133 above the insulating layer 123 and forming an anti-reflection layer 135 below the transparent substrate 121. The method according to the present invention may further include forming a lower adhesive layer 131 between the transparent substrate 121 and the anti-reflection layer 135 and forming an upper adhesive layer 132 between the insulating layer 123 and the protecting layer 133.

FIG. 4 is a view for explaining an operating manner of the touch panel shown in FIG. 1. When a touch surface is pressed by a stylus pen (141), parasitic capacitance is easily measured by the second sensing electrodes 122b and then a change in capacitance is sensed, and thus a coordinate of a pressed location can be recognized.

In the touch panel 100 according to the preferred embodiment of the present invention, a capacitive type touch panel can be manufactured by using two-layered electrode patterns 122a and 122b. However, the touch panel according to the present invention is not limited thereto, and various types of touch panel including the foregoing components can be manufactured.

As set forth above, the touch panel according to the present invention can easily sense a change in capacitance to maximize sensing sensitivity and thus allow accurate coordinate measurement even if a touch input does not have a sufficient area, by forming a two-layered electrode layer composed of the first sensing electrodes and the second sensing electrodes.

Although the embodiments of the present invention have been disclosed for illustrative purposes, it will be appreciated that the present invention is not limited thereto, and those skilled in the art will appreciate that various modifications, additions and substitutions are possible, without departing from the scope and spirit of the invention.

Accordingly, any and all modifications, variations or equivalent arrangements should be considered to be within the scope of the invention, and the detailed scope of the invention will be disclosed by the accompanying claims.

What is claimed is:

1. A touch panel, comprising:
a transparent substrate;
first sensing electrodes formed in a first direction on one surface of the transparent substrate to sense a change in capacitance at the time of inputting a touch;
second sensing electrodes disposed in the first direction on a surface, which is in parallel spaced from the surface on which the first sensing electrodes are formed, alternately with the first sensing electrodes, to sense a change in capacitance at the time of inputting a touch; and
driving electrodes formed in a second direction crossing the first direction on the other surface of the transparent substrate.

2. The touch panel as set forth in claim 1, further comprising an insulating layer formed on the transparent substrate, the first sensing electrodes and the second sensing electrodes being formed in the insulating layer.

3. The touch panel as set forth in claim 1, wherein the first sensing electrodes and the second sensing electrodes for each occurrence are uniformly disposed at a predetermined arrangement pitch.

4. The touch panel as set forth in claim 1, further comprising an anti-reflection layer formed below the transparent substrate.

5. The touch panel as set forth in claim 4, further comprising a first adhesive layer allowing the transparent substrate and the anti-reflection layer to adhere to each other.

6. The touch panel as set forth in claim 2, further comprising a protecting layer formed above the insulating layer.

7. The touch panel as set forth in claim 6, further comprising a second adhesive layer allowing the insulating layer and the protecting layer to adhere to each other.

8. The touch panel as set forth in claim 6, wherein the protecting layer is formed of any one of glass, polyethylene terephthalate (PET), and a hard coat film.

9. A method for manufacturing a touch panel, the method comprising:
forming first sensing electrodes in a first direction on an upper surface of a transparent substrate and second sensing electrodes in the first direction on a surface, which is in parallel spaced from the surface on which the first sensing electrodes are formed, alternately with the first sensing electrodes; and
forming driving electrodes in a second direction crossing the first direction on a lower surface of the transparent substrate.

10. The method as set forth in claim 9, further comprising forming an insulating layer covering the first sensing electrodes and the second sensing electrodes.

11. The method as set forth in claim 9, further comprising:
forming a protecting layer above the insulating layer; and
forming an anti-reflection layer below the transparent substrate.

12. The method as set forth in claim 9, further comprising:
forming a first adhesive layer between the transparent substrate and the anti-reflection layer; and
forming a second adhesive layer between the insulating layer and the protecting layer.
